(19) United States
(12) Patent Application Publication
(10) Pub. No.: US 2006/0020822 A1
(43) Pub. Date: Jan. 26, 2006

(54) Device and method for calculating encrypted data from unencrypted data or unencrypted data from encrypted data

(75) Inventors: Manfred Aigner, Graz (AT); Holger Bock, Graz (AT)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/193,038

(22) Filed: Jul. 29, 2005

Related U.S. Application Data
(63) Continuation of application No. PCT/EP04/00813, filed on Jan. 29, 2004.

(30) Foreign Application Priority Data
Jan. 30, 2003 (DE) 103 03 723.3

(51) Int. Cl. G06F 12/14; H04L 9/32; G06F 11/30; G06F 11/00; G06F 11/22; G06F 11/32; G06F 11/34; G06F 11/36; G06F 12/16; G06F 15/18; G08B 23/00

(52) U.S. Cl. 713/189; 726/22

(57) ABSTRACT

In a device for calculating encrypted data from plaintext data or plaintext data from encrypted data, in which a cryptographic algorithm having an initial stage, an intermediate stage or final stage and an intermediate stage upstream of the final stage is implemented, the processor for performing the cryptographic algorithm is formed such that it performs either the initial stage or the final stage or both the initial stage and the final stage in a manner protected against a cryptographic attack, whereas the intermediate stage is performed in a manner unprotected against a cryptographic attack.

### CROSS-REFERENCE TO RELATED APPLICATION

This application is a continuation of copending International Application No. PCT/EP04/00813, filed Jan. 29, 2004, which designated the United States and was not published in English, and is incorporated herein by reference in its entirety.

### BACKGROUND OF THE INVENTION

1. Field of the Invention

The present invention relates to cryptography concepts and, in particular, to the protection of cryptography concepts against attacks.

2. Description of Prior Art

FIG. 3a exemplarily shows an illustration of the well-known DES algorithm which is, for example, described in chapter 7.4.2 of “Handbook of Applied Cryptography”, Menezes and others, CRC Press, 1996. The DES is a Feistel encryption algorithm processing plaintext blocks having n=64 bits to generate blocks of encrypted data having a size of 64 bits, and vice versa. The effective size of the secret key K is k=56 bits. In particular, the input key is specified as a 64-bit key, wherein 8 bits may be employed as parity bits. The 2⁵⁶ keys implement 2⁵⁶ of the 2⁶⁴ possible bijections in 64-bit blocks.

Referring to FIG. 3a, the input data is input at a block 30 and at first subjected to an initial permutation (IP) 31. Subsequently, the bits of this so-called 0-th round are separated into a left block L₀ and a right block R₀, as is indicated in FIG. 3a at 32. The data is then processed in a first round of the DES algorithm using a round function 33 generating, from a first round key K₁ and the right data block R₀, output data which is XOR-operated 34 with the left data to generate new right data R₁.

The new left data L₁ corresponds to the old right data R₀. In FIG. 3a, the first round, that is the processing using the first round key K₁, is referred to as the initial stage 1. In an initial stage 2 following the initial stage 1, the same procedure as is illustrated in the block circuit diagram of FIG. 3a is performed, this time with the result of the XOR operation 34 as the input into the cryptographic function 33. In this second round or initial stage 2, however, a second round key K₂ is used to XOR-operate 35 the output data of the function 33 of the initial stage 2 with the old right data R₀ (which is the new left data L₁) This procedure is performed for the intermediate stages or rounds 3 to 14 one after the other. All in all, the DES algorithm has 16 rounds. In the 15^{th} round, which is referred to as final stage 1 in FIG. 3a, a 15^{th} round key K₁₅ is used (not shown in FIG. 3a). In a last final stage of the DES algorithm, which is the 16^{th} round and in FIG. 3a is also referred to as final stage 2, the cryptographic function 33 is performed for a last time using the 16^{th} round key K₁₆ and the corresponding input data R₁₅ to XOR-operate 36 the output data of the cryptographic function 33 of the 16^{th} round with the left data block L₁₅ of the previous round to subsequently, as is shown in FIG. 3a, rearrange the left and right data again (block 37).

The data arranged in the manner indicated in block 37 of FIG. 3a is then subjected to a final permutation which is inverse to the initial permutation 31 and is referred to by 38 in FIG. 3a. At the output of block 38, there is the encrypted data, more precisely a block of encrypted data, as is illustrated by 39. The entire procedure is reversed to perform a decryption.

FIG. 3b shows the internal function f (33 in FIG. 3a) of the DES algorithm. The right data Rᵢ₋₁ of the previous stage or the previous round is subjected to an expansion 40 and then XOR-operated 41 using the round key Kᵢ to be subsequently arranged into eight groups of 6 bits each (42). After that, a substitution operation is performed using eight different predefined tables 43 which are referred to as SBOXES in the art. Each of the SBOXES provides a 4-bit value at its output. The output data of the substitution operation 43 is then arranged in blocks (44) to be subjected to a permutation operation 45. The output data of the permutation 45 thus forms the output data of the cryptographic function 33 of FIG. 3a which is also referred to as a round function.

The DES algorithm is a so-called block cipher because it calculates a block of output data (39 in FIG. 3a) from a block of input data (30 in FIG. 3a). Thus, there are different block cipher types which are listed in chapter 7 of the book mentioned above. In general, a block encryption algorithm having several stages looks as is indicated in FIG. 4. Such a multiple encryption algorithm, at the input side, receives the unencrypted data which is also referred to as plaintext P. It is subjected to an initial stage of an overall encryption algorithm, which in FIG. 4 is referred to by 46. A first key K₁ is used in the initial stage. The output data A of the initial stage is then fed to an intermediate stage 47 performing an alternative or equal encryption operation as the initial stage, this time, however, using the key K₂ which is typically different from the key K₁. The output data B of the intermediate stage is then fed to a final stage 48 performing another encryption operation, this time, however, using another key K₃ of the final stage which is typically different from the key K₁ of the initial stage 46 and the key K₂ of the intermediate stage 47. The encrypted data block or cipher text C results at the output of the final stage 48.

The DES algorithm described in FIGS. 3a and 3b is based on two general concepts, namely the product encryption algorithm and the Feistel encryption algorithm. Each principle includes iterating a common sequence or round of operations. The basic idea of a product encryption algorithm is to set up a complex encryption functionality by putting together several simple operations which, considered together, are relatively safer, but considered individually do not provide sufficient protection. These basic operations include transpositions, translations (such as, for example, XOR) and linear transformations, arithmetic operations, modular multiplications and simple substitutions. A product encryption algorithm thus combines two or several transformations of different kinds in a manner that the resulting encryption is safer than the individual components.

A Feistel encryption algorithm is an iterated encryption mapping of a 2 t-bit plaintext (exemplarily t-bit blocks L₀ and R₀ in an encryption text (Rᵣ, L_{R})), namely by a process having r rounds, R being greater than or equal to 1. Typically, a round number of r≧3 is preferred, wherein r often is an even number. A typical feature of the Feistel structure is for the blocks of the left data and the right data to be exchanged from round to round.

The decryption is obtained by performing the same r round process, but using sub-keys used in a reversed order, that is from Kᵣ to K₁. The encryption function of the Feistel encryption algorithm may be a product encryption algorithm, wherein f itself need not be invertible to allow an inversion of the Feistel encryption algorithm.

It becomes obvious from the previous discussion of well-known encryption algorithms that modern encryption algorithms typically include a sequence of identical round functions (FIG. 3a) or generally a cascade of same or different encryption concepts, wherein each of the algorithms considered comprises an initial stage, at least one intermediate stage and a final stage, wherein in the processing of each of the stages mentioned, that is the initial stage, the intermediate stage or the final stage, a secret or a part of this secret is typically processed, namely a key K₁, . . . , Kₙ, which—for a symmetrical algorithm—must be known to the entity performing the encryption operation on the one hand and to the entity performing the decryption operation on the other hand.

A character of cryptographic algorithms is that information is encrypted which is sensitive in a certain way, that is should not be accessible for third parties. This has the direct result that attacks against cryptographic algorithms are developed and performed to obtain sensitive information without knowing the key. Since the basic structure of the cryptographic algorithms mentioned above is publicly known, which means that the only component unknown for the attacker is the key itself and maybe the plaintext, some attacks are aimed at obtaining the key in certain manner. As soon as an attacker has obtained a key, he or she has “cracked” the cryptographic system. It is to be mentioned here that the most valuable information for the attacker is the key itself. Nevertheless, attacks in which only the plaintext but not the key itself is cracked, are conceivable. These attacks, however, are sub-optimal since, without knowing the key, complex work must be done for each attack, which is not the case when the key itself has been cracked.

There are various types of attacks against cryptographic systems, that is cryptographic attacks. The DPA attack described here is also referred to as an implementation attack as a special form of a cryptographic attack since the attack is not directly directed to the cryptographic system but to an implementation of the system.

A particularly dangerous cryptographic attack which in principle may be performed easily has been presented by P. Kocher, J. Jaffer and B. Jun. This cryptographic attack is referred to as a DPA attack in the art. DPA means differential power analysis. In particular, the difference of two mean values of power measurements is analyzed to establish the secret key of a cryptographic calculation performed by an electronical device. A DPA attack basically includes two parts, namely many precise measurements of the power consumption of an electronical device while executing a well-known cryptographic algorithm, wherein the same key (which is not known from the beginning but is the target of the attack) is used and the data to be encrypted is varied. The second part of the DPA attack includes a statistical calculation using the power measurement data to verify the correctness of an assumption, that is of the key hypothesis, for a certain part of the key, such as, for example, 6 bits.

A particular “advantage” of the DPA attack is that the circuit itself need not be manipulated at all. Only the power consumption of the circuit must be measured somewhere outside the electronical device at a well accessible position. Furthermore, so-called reverse engineering need not be performed. It is irrelevant where on the chip the calculations are performed, particularly when taking into account that on a chip there are typically not only the cryptoprocessor, but also other components.

Additionally, it is irrelevant at which time the cryptographic calculations on the chip are performed since the power can be measured in a time interval. Furthermore, it is not necessary for an attacker performing a DPA attack to understand the nature of the DPA attack. When he or she knows how to proceed, and when he or she is in possession of software for the statistical calculations, the attacker need not understand why the DPA attack works. Thus, the DPA attack principally is a cheap and simple attack. An attacker only requires precise measuring equipment since the DPA attack is principally based on obtaining a signal-to-noise ratio. Additionally, the attacker must repeatedly execute a well-known algorithm. Consequently, he must be able to provoke execution of the algorithm with the same key and varying input data.

Since the DPA attack particularly also builds other related cryptographic attacks to the power consumption of the circuit performing a cryptographic algorithm, efforts made for a protection against DPA attacks are to homogenize the power consumption of the circuit. In the ideal case, such a circuit optimally protected against DPA attacks always shows the same power consumption behavior, independently of the data to be encrypted, so that a DPA attacker may perform its DPA attack, but the same power profile will always be obtained for all the different input data. In this case where the same power profile has always been measured, the statistical analysis will fail and no significant results will be provided so that the DPA attack is doomed to fail.

Typical circuits are built in CMOS technology. Circuits built in CMOS technology only consume a negligible amount of power, when there are no changes of states. A power consumption will only arise when a CMOS circuit switches from one state (such as, for example, a logical 1) to the complementary state (a logical 0), and vice versa. Additionally, conventional CMOS circuits have the characteristic that changes from 0 to 1 (0, for example, corresponds to a voltage of 0 V or Vss, whereas “1”, for example, corresponds to a high voltage Vdd) have a different power consumption than state changes in the opposite direction. The power profile of the circuit in a change from 1 to 0 thus differs from that in a change from 0 to 1. In order to homogenize this power consumption, it has been known to provide a dual-rail circuit 50, as is illustrated in FIG. 5.

In a dual-rail circuit, each logical function and each connection line between logical functions is formed in duplicate. One path (rail) processes the actual useful bit, whereas the other path processes the bit complementary to the useful bit, in parallel. When a change from 1 to 0 takes place on the first rail, at the same time a change from 0 to 1 takes place on the other rail. A peak having double the height, which has, however, the same height for each change on the useful path (and thus on the complementary path), results in the power consumption of this circuit compared to a single rail setup.

It is, however, still problematic with a dual-rail circuit that there is no peak in the power consumption when a state in a clock equals the state in the following clock, that is when there is no change in state. An attacker cannot differentiate whether a change from 0 to 1 or from 1 to 0 has taken place. But he can see from the power profile whether a change in state has taken place or not.

In order to close this gap, dual-rail technology is supplemented by the pre-charge or pre-discharge technology.

A so-called preparation clock Pr is connected between each useful clock N, as is indicated in FIG. 5 by a clock generator 51. In the useful clock, the dual-rail circuit performs the usual calculation given by a cryptographic algorithm. In the preparation clock, the two complementary lines, such as, for example, x₁, NOTx₁, are placed in the same state. In the case of pre-charge, this state is the high voltage state. In the case of pre-discharge, this state is the low voltage state. Depending on in which setting the dual-rail circuit 50 is embedded, the pre-charge or pre-discharge may be performed by preparing means 52 schematically illustrated in FIG. 5 at the input of the dual-rail circuit (xᵢ) or at the output of the dual-rail circuit yᵢ or both at the input and the output.

The usage of the pre-charge technology has the advantage that, as is illustrated in the table of FIG. 6, the same number of states will always change from one clock to the next, that is from a pre-charge/pre-discharge clock to a useful clock, independently of which states the useful bits to be processed and the bits complementary to the useful bits have. Thus, at a transition from the state 60 of FIG. 6 to a state 61 in a useful clock of FIG. 6, two states will change in the case of pre-charge (all lines are at “1”) (NOTx₁, x₂) and also two states will change in the case of pre-discharge. With a change from the state 61 to a state 62, exactly two bits will change in the case of pre-charge and also two bits will change in the case of pre-discharge. Additionally, a change of two bits will take place when a change takes place from the state 62 to a state 63. The dual-rail technology thus has the decisive advantage that an attacker cannot differentiate between a change from 0 to 1 or from 1 to 0 (due to dual-rail technology) and that the attacker can no longer see using the power profile whether a change in state has taken place on a line or not.

Although dual-rail technology including pre-charge/pre-discharge provides an effective protection against DPA attacks, it has its price. The chip consumption of the dual-rail circuit has double the size compared to the case where this circuit is formed in single rail. Additionally, the energy consumption of such a circuit in dual-rail technology is up to double as high as in the case of dual-rail technology without pre-charge and even—due to the duplicate design of the circuit—four times as high as a simple unsafe single rail circuit. Furthermore, providing pre-charge/pre-discharge clocks between the useful clocks results in the data throughput, related to a number of clock cycles, having half the size.

In summary, dual-rail technology including pre-charge/pre-discharge results in a DPA-safe circuit implementation.

This safety, however, has its price, namely a chip area consumption having up to double the size and an energy consumption increased up to four times compared to an unprotected circuit.

### SUMMARY OF THE INVENTION

It is an object of the present invention to provide a safe and nevertheless efficient cryptography concept.

In accordance with a first aspect, the present invention provides a device for calculating encrypted data from plaintext data or for calculating plaintext data from encrypted data using a cryptographic algorithm having an initial stage, at least one downstream intermediate stage or a final stage and at least one upstream intermediate stage, wherein the plaintext data or the encrypted data or input data derived from the plaintext data or the encrypted data may be fed to the initial stage, wherein final output data from which the encrypted output data or the plaintext output data may be derived or the encrypted data or decrypted data may be output from the final stage, wherein output data of the initial stage may be fed to the at least one intermediate stage, and wherein output data of the intermediate stage upstream of the final stage may be fed to the final stage, having: processor means for performing the initial stage, the at least one intermediate stage and/or the final stage of the cryptographic algorithm, wherein the processor means is formed to perform the initial stage and/or the final stage in a manner protected against a cryptographic attack and to perform the at least one intermediate stage in a manner unprotected against a cryptographic attack.

In accordance with a second aspect, the present invention provides a method for calculating encrypted data from plaintext data or for calculating plaintext data from encrypted data using a cryptographic algorithm having an initial stage, at least one downstream intermediate stage or a final stage and at least one upstream intermediate stage, wherein the plaintext data or encrypted data or input data derived from the plaintext data or the encrypted data may be fed to the initial stage, wherein final output data from which the encrypted output data or the plaintext output data may be derived or the encrypted data or decrypted data may be output from the final stage, wherein output data of the initial stage may be fed to the at least one intermediate stage, or wherein output data of the intermediate stage upstream of the final stage may be fed to the final stage, having the step of: performing the initial stage and/or the final stage in a manner protected against a cryptographic attack, and performing the at least one intermediate stage in a manner unprotected against a cryptographic attack.

In accordance with a third aspect, the present invention provides a computer program having a program code for performing the above mentioned method for calculating encrypted data from plaintext data or plaintext data from encrypted data, when the computer program runs on a computer.

### BRIEF DESCRIPTION OF THE DRAWINGS

Preferred embodiments of the present invention will be detailed subsequently referring to the appended drawings, in which:

FIG. 1 is a block circuit diagram of an inventive device for calculating encrypted data from plaintext data or vice versa;

FIG. 2 shows a preferred embodiment of the device illustrated in FIG. 1;

FIG. 3a is a block circuit diagram of the course of the DES algorithm;

FIG. 3b is a block circuit diagram of the round function f of the DES algorithm of FIG. 3a;

FIG. 4 is a block circuit diagram of a general cascading cryptoalgorithm;

FIG. 5 is a principle circuit diagram of a dual-rail circuit having pre-charge/pre-discharge; and

FIG. 6 shows a table for illustrating the mode of action of pre-charge/pre-discharge.

### DESCRIPTION OF PREFERRED EMBODIMENTS

The present invention is based on the finding that it is sufficient for defeating cryptographic attacks in cryptographic algorithms comprising an initial stage and a subsequent stage or final stage and a previous stage, to only protect the initial stage and/or the final stage against cryptographic attacks. According to the invention, it is, however, not required to protect the intermediate stage or the typically several intermediate stages against cryptographic attacks as long as the stage downstream of the initial stage is based and depends on output data output by the initial stage when calculating.

By way of analogy, it is sufficient for a reverse attack, which is also conceivable, that is for an attack performed starting from encrypted data, to only protect the final stage against the attack, but not the stage in front of the final stage, which will typically be an intermediate stage.

Put differently, it is sufficient in such cascading algorithms where an intermediate stage is based on results of the previous or subsequent stage, to only protect the first and/or the last stage against cryptographic attacks, whereas the intermediate stage or the several intermediate stages are only implemented using reduced safety or no safety at all, that is are operated in an unprotected mode of operation.

This of course permits attacks to the stages operated in an unprotected mode of operation. These attacks, however, will not be of use because a clear hypothesis cannot be put forward since the input data in the unprotected stage has already been encrypted using a secret key (or decrypted in the case of a decryption).

Figuratively, the present invention is based on the finding that it is sufficient to protect a forbidden way by only securely blocking the input and output doors, but not intermediate doors also present in the way, since an attacker figuratively cannot reach the intermediate door when the input and the output door of the way are protected optimally.

As has been explained before, a protection against cryptographic attacks will always directly entail considerably increased costs for chip area, energy consumption and, maybe, processing time. The inventive calculation of intermediate stages in an unprotected mode thus directly results in saving energy, maybe chip area and maybe time. When, however, the input stage and/or the final stage is/are protected optimally, that is when these stages are performed in a way protected against cryptographic attacks, safety losses do not have to be put up with.

Consequently, the present invention provides a, on the one hand, safe and, on the other hand, more efficient concept for calculating encrypted output data from plaintext input data or—in the case of a decryption—concept for calculating plaintext input data from encrypted output data.

Thus, an advantage of the present invention is that the costs are reduced at least with regard to a current/energy demand, whereas a successful defense against DPA attacks to cryptographic circuits can nevertheless be ensured when, as is the case in a preferred embodiment, a dual-rail pre-charge logic is used as a measure for safely performing the input stage and/or the final stage of a cryptographic algorithm.

In contrast to an application where DPA attacks are to be warded off by, for example, employing a dual-rail pre-charge logic for a DES module, where the pre-charge process has been performed during the entire calculation of the DES algorithm, which would result in a considerably increased energy consumption compared to non-DPA-protected circuits of the same function, the increased energy consumption is, according to the invention, only accepted where this is necessary, namely for performing the initial stage and/or the final stage of the cryptographic algorithm in a protected manner.

Since the DPA is based on a calculation of a part of the DES algorithm having to be executed for checking the assumption (hypothesis) about the “target bit”, wherein an attack typically takes place in rounds 2 or 15 of 16 DES rounds, rounds 3 to 14 are not protected particularly according to the invention when the attack to the round keys of rounds 2 and/or 15 has already been warded off successfully. It is recognized according to the invention that at least performing the pre-charge process in rounds 3 to 14 is a waste in energy when it is ensured that the sub-keys from rounds 1 and 2 (of the initial stage) and/or 15 and 16 (of the final stage) can be “defended” successfully.

The present invention consequently also includes a flexible control for a core having dual-rail pre-charge capability for the cryptographic algorithm considered, which forbids the pre-charge process in rounds 3 to 14 to save current, whereas at the same time the safety level of the entire DES calculation is not deteriorated. In one preferred embodiment of the present invention, control operating knowing the “endangered” and the “unendangered” rounds of a cryptographic calculation is provided to only activate the energy-intense pre-charge/pre-discharge mode in the “endangered” rounds.

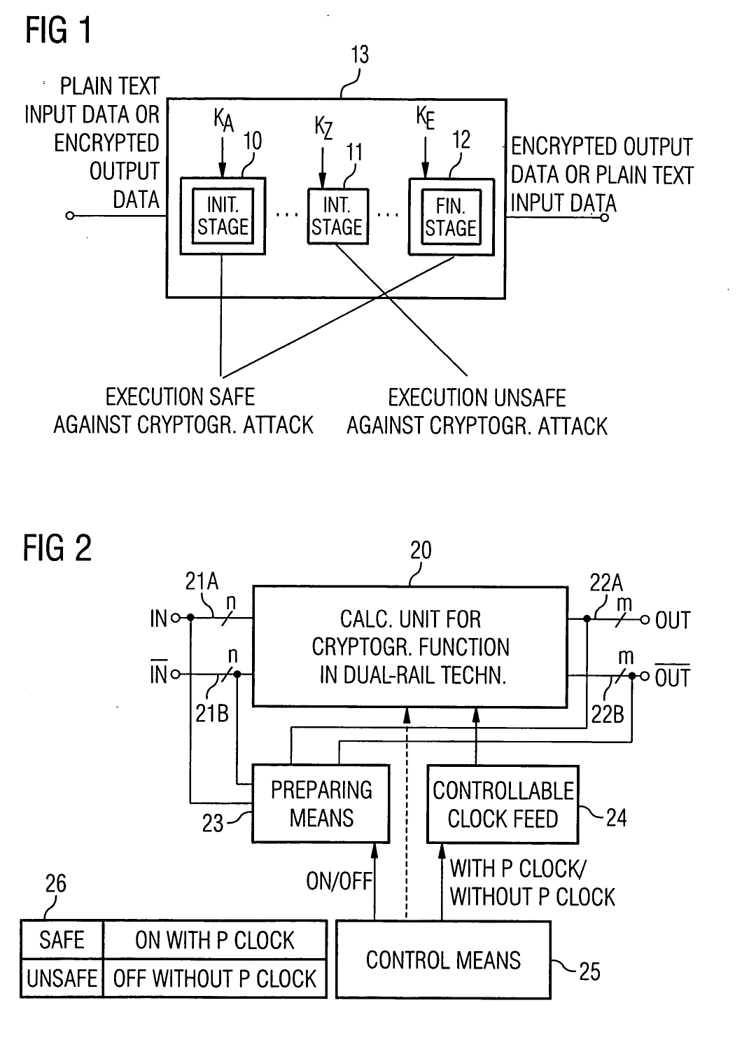

FIG. 1 shows a block circuit diagram of a preferred embodiment of the present invention. In particular, FIG. 1 shows a device for calculating encrypted data from plaintext data or vice versa, that is for calculating plaintext data from encrypted data. A cryptographic algorithm which, in the embodiment shown in FIG. 1, comprises an initial stage 10, at least one intermediate stage 11 and a final stage 12, is used for this.

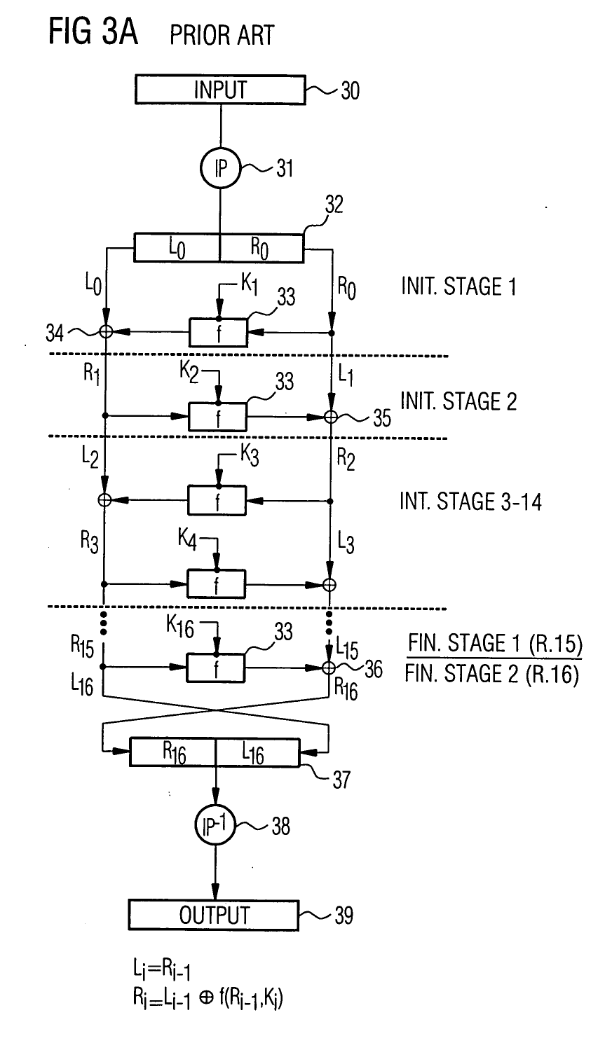

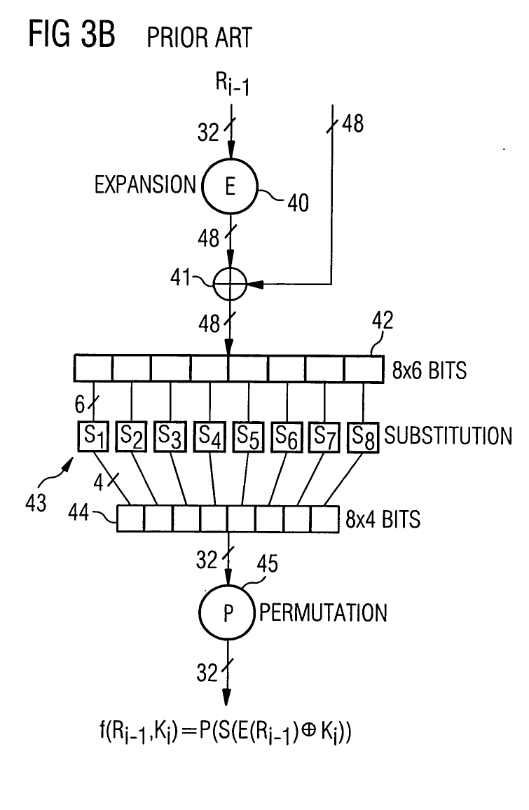

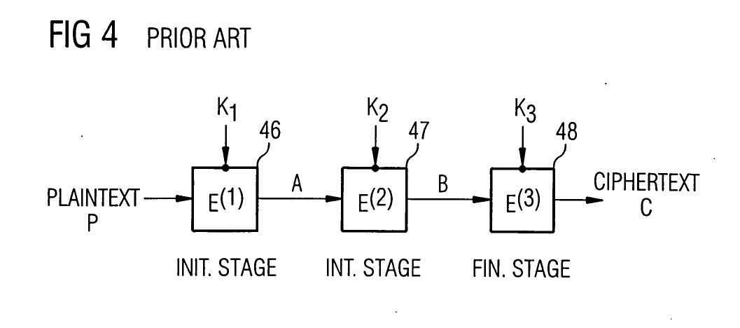

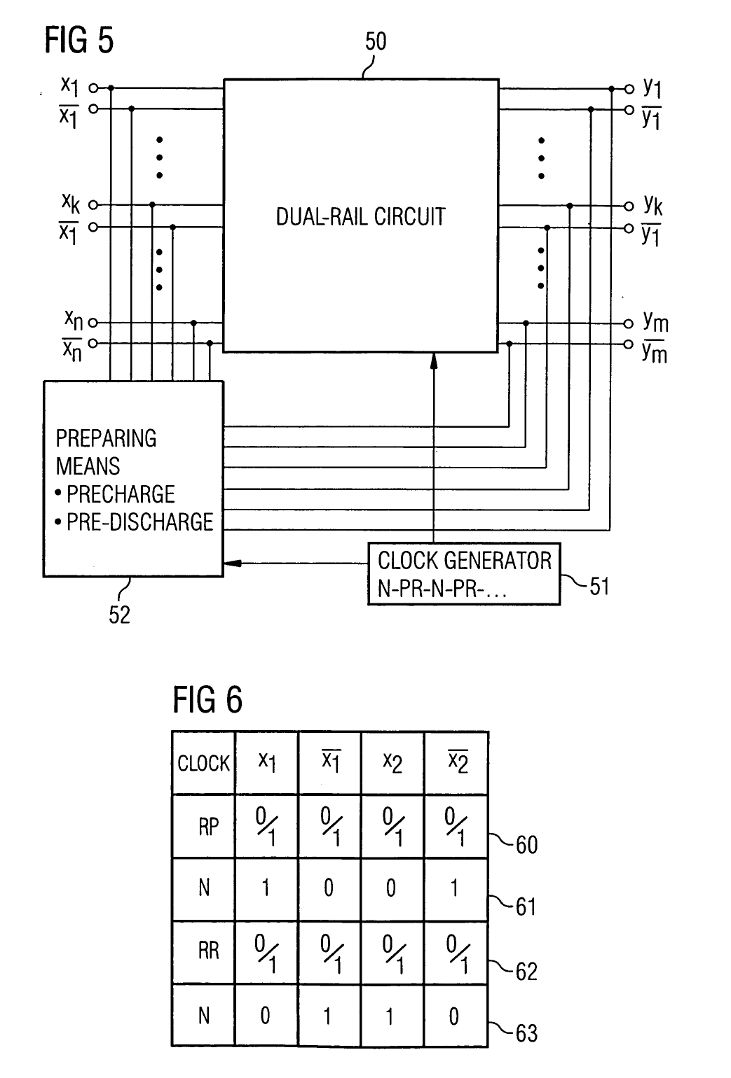

When the device shown in FIG. 1 is employed for encrypting, that is for generating encrypted output data from plaintext input data, the plaintext input data is fed to the input stage 10, or input data which has been derived from the original plaintext input data without using a key. Plaintext input data derived in this way, which may be fed to the input stage 10, is, for example, the output data of the initial permutation 31 of FIG. 3a representing the DES algorithm.

It is to be pointed out here that the keys for the stages of the algorithm may be dependent on one another or not. In the case where the stages are rounds of, for example, the DES algorithm, the keys are dependent on one another because they are all derived from a common “supreme key”. Alternatively, the keys may also be independent of one another for stages independent of one another, such as, for example, in the triple DES.

Encrypted data which has been encrypted using the key K_{A} provided to the input stage 10 is output from the initial stage 10. This output data of the initial stage 10 is then fed to the intermediate stage 11 in order for it to perform another encryption of the output data of the initial stage 10 already encrypted, wherein the intermediate stage 11 uses a key K_{I} for this, as is shown in FIG. 1. Encrypted output data of the intermediate stage 11 which now has been encrypted using two keys K_{A} and K_{I}, which are preferably different, is then fed to the final stage 12 (possibly after being processed in intermediate stages between the intermediate stage 11 and the final stage 12) to be encrypted again there using the key K_{E} to finally obtain the encrypted output data or output data from which the encrypted output data is derived. This derivation rule may again take place without using a cryptographic key and corresponds, for example, to the inverse permutation 38 of FIG. 3a, taking the example of the DES algorithm.

The processor means for performing the initial stage 10, the at least one intermediate stage 11 or the final stage 12 of the cryptographic algorithm is formed to execute the initial stage 10 and/or the final stage 12 in a manner protected against a cryptographic attack, which is illustrated in FIG. 1 by a double border. The processor means 13 is also formed to execute the intermediate stage 11 in a manner unprotected against a cryptographic attack.

In this context, it is to be mentioned that performing the intermediate stage 11 need not be completely unprotected against a cryptographic attack, but only—compared to performing the initial stage 10 and the final stage 12—less protected, that is using fewer or no counter measures against a cryptographic attack. When high security is aimed at, this directly results in high costs for chip area, energy and, maybe, time. When, however, less safety is required for a calculation, this directly results in reduced costs for energy, maybe chip area and maybe time.

The inventive device shown in FIG. 1 thus results in reducing the costs compared to the case where the initial stage 10, the intermediate stage 11 and the final stage 12 are all executed in a manner protected against a cryptographic attack, since additional costs for safety, at least when calculating the intermediate stage, are not incurred or only to a limited extent.

According to the invention, it is assumed that an attacker may, if he or she likes to do so, attack the intermediate stage, in case he or she is in the position to do so, when it is kept in mind that the output data and input data are present somewhere on the chip and thus accessible only with difficulty. Should an attacker, however, succeed in performing an attack to the intermediate stage, this is of no use to him or her since he or she cannot put forward a sensible hypothesis, since even the input data in the intermediate stage has been encrypted using the key K_{A} in FIG. 1. After the initial stage 10 has been calculated in a safe manner, an attacker will not succeed in finding out the secret key K_{A} of the initial stage.

In the preferred embodiment of the present invention shown in FIG. 1, safety need not be compromised. At least energy savings and, in some implementations, even time and chip area savings are obtained, as will be explained later, with an equal safety level compared to a completely protected embodiment of the algorithm.

In an alternative embodiment where only a so-called forward attack is possible, which will principally depend on the kind of the cryptoalgorithm employed, it is sufficient to only protect the initial stage 10 and to execute the intermediate stage 11, which in this case might also be the final stage, in an unprotected manner and at low cost. In this case, a cryptographic algorithm would have at least two stages, namely the initial stage 10 and the downstream intermediate stage 11 which is at the same time the final stage. In this case, it is possible to only protect the initial stage 10.

In an alternative embodiment of the present invention, only reverse attacks are possible. In this case, it is necessary to protect the final stage 12, but not so the intermediate stage 11 which in this case might at the same time be the initial stage. If such an algorithm had three stages, a single initial stage would be present, which would not have to be protected either due to the cryptographic attacks only having an effect from the output to the input.

The inventive device thus ensures by protecting either the first stage 10 or the last stage 12 or the first stage 10 and the last stage 12 that at least DPA attacks will fail, wherein at the same time savings in chip area, energy or time are obtained by an unprotected calculation of the intermediate stages which cannot be attacked due to a lacking hypothesis.

When the processor means shown in FIG. 1 is implemented such that it comprises an individual calculating unit for the initial stage 12, an individual calculating unit for the intermediate stage 11 and an individual calculating unit for the intermediate stage 12, in the preferred embodiment where the initial stage and the final stage are protected, these will be executed at least in dual-rail or even better in dual-rail having pre-charge, whereas the calculating unit implementing the intermediate stage 11 of the algorithm is implemented in simple single rail technology without pre-charge. With regard to the intermediate stage 11, this results in a chip area halving for the calculating unit for the intermediate stage 11 compared to a dual-rail implementation. Additionally, energy savings of about 75% are obtained compared to a complete implementation having dual-rail and pre-charge. Furthermore, a faster clocking is possible or, adapted to the clock rates of the output stage and the input stage, a slower clocking also entailing diminished energy consumption and more simple clock generator circuits.

In an alternative embodiment of the present invention, which is illustrated in FIG. 2, the iterative structure of an algorithm is utilized in that a single calculating unit is provided to calculate, for example, all the actually identical round functions f (block 33 in FIG. 3a) of, for example, the DES algorithm. Such a calculating unit is schematically illustrated in FIG. 2 at 20. Since the calculating unit is to calculate both the initial stage 10 and the final stage 12 of FIG. 1 in a protected way, the calculating unit for the cryptographic function is built in dual-rail technology. Thus, it includes a useful input 21a having a certain width of n bits and a complementary input 21b having the same bit width n. The calculating unit 20 includes a useful output 22a and a complementary output 22b, both having a bit width m, wherein m may equal n in the DES algorithm, although this is not essential for the present invention.

The processor means shown in FIG. 2 also includes preparing means 23 performing pre-charge or pre-discharge by charging or discharging the inputs 21a, 21b and/or the outputs 22a, 22b of the calculating unit 20 to the same voltage level, as has already been explained referring to the table shown in FIG. 6. The processor means shown in FIG. 2 also includes a controllable clock feed 24 which may be controlled by control means 25 as is the case for the preparing means 23. The processor means shown in FIG. 2 also includes, to be suitable for the DES algorithm, a data input/output multiplexer not shown in FIG. 2, and a key generator for deriving the round keys Kᵢ, etc., when this function is executed externally, and at least one key feed not illustrated in FIG. 2 either. The data input/output multiplexer and the key feed make sure that the calculating unit 20 is fed the correct data in each round of the DES algorithm shown in FIG. 3a and that the output data of the calculating unit is processed correctly at the outputs 22a and 22b or subjected to the XOR operation, etc., in case the corresponding XOR operation 34 is arranged outside the calculating unit 20 for the cryptographic function.

The control means 25 is operative to control, when the processor means 13 performs the initial stage 10 of FIG. 1 of the cryptographic algorithm, the preparing means 23 and the controllable clock feed 24 in that a pre-charge/pre-discharge operation takes place in that the inputs and/or outputs of the calculating unit 20 are prepared correspondingly (by charging or discharging to the same value) and in that at the same time the controllable clock feed 24 performs, on a useful clock, a pre-charge clock or pre-discharge clock (P clock) in order for the calculating unit 20 for cryptographic functions which is executed in dual-rail technology anyway to provide an optimally safe power profile.

When the calculation of the initial stage of the algorithm is complete, this is known to the control means 25 when controlling the course of the entire algorithm, or it is communicated to the control means 25 by a central control. In this case, the calculating unit 20 is switched from its protected calculating mode to the unprotected calculating mode by deactivating the preparing means 23 (OUT) and by addressing the controllable clock feed 24 to no longer provide a pre-charge clock. In the unprotected mode, the calculating unit 20 will only obtain useful clocks from the controllable clock feed 24.

If the data throughput of the processor means is the same in the protected mode and the unprotected mode, the controllable clock feed 24 will only have to provide half as many clock impulses in the unprotected calculating mode, which results in at least a halving of the energy consumption compared to the protected calculating mode for the initial stage and final stage.

In order to keep interventions to the dual-rail calculating unit 29 as small as possible, the complementary rail of the calculating unit 20 may still “run along” in the unprotected calculating mode, although this is not absolutely necessary. For a further reduction in the energy consumption, the control means 25 in an alternative embodiment of the present invention may also be formed to deactivate the second rail, that is the complementary rail, in the calculating unit 20, as is illustrated in FIG. 2 by the broken control arrow, such that no power is consumed by this complementary rail in the unprotected calculating mode, which will result in a further essential reduction in the energy consumption.

Even if the complementary rail runs along in the unprotected calculating mode, and the pre-charge/pre-discharge clock (preparation clock) is dispensed with for reasons of saving energy, even the halving of the number of the clock edges results in an essential energy saving which may further be increased for certain designs for the following reasons. Typically, an operating clock on a chip is generated using a so-called clock tree. A precise clock oscillator providing a precise master clock at a certain operating frequency, is situated at the root of a clock tree. Clocks having different clock rates may be derived from this master clock by division or multiplication. Since usually only a limited number of clock generators, in an extreme case only a single clock generator, are present on a chip and the clock or the different clocks must be distributed to many positions on the chip, several clock amplifiers, which also consume considerable amounts of energy, are also present in the clock tree. If the clock tree is formed such that the controllable clock feed 24 comprises clock access for a “safe” clock comprising a useful clock impulse and a preparation clock impulse, and if the controllable clock feed 24 is also formed to feed, in parallel, to the calculating unit an “unprotected” operating clock having half the clock frequency compared to the safe clock, energy savings may already be obtained when, in the case of the unprotected mode, switching takes place from the “safe” clock to the “unprotected” clock. If, however, the “safe” clock is deactivated directly when generated, that is at the uppermost position possible in the clock tree, the clock amplifiers present in the clock tree for the safe clock will also be deactivated such that they will not consume energy.

It is to be pointed out here that the energy consumption often is not an important aspect for applications connected to a power supply network. This, however, is completely different when the inventive device is to be employed in a contact-free application, such as, for example, on a chip card which does not have its own power supply. When the chip card is placed near a terminal, it draws its power from an RF field generated by the terminal. In this case, the terminal can, when the chip card has smaller an energy consumption, be operated at lower a radiation power, that is may be designed cheaply. For the chip card, this means that the antenna/rectifier arrangement can be dimensioned to be smaller and thus be designed cheaper by extracting energy from the RF field, which may, regarding chip cards which typically reach very high numbers, result in cost savings and thus a price reduction on the high competition market.

In summary, the instructions for the control means 25 are indicated in a box 26. In the protected mode for the initial stage 10 and/or the final stage 12, the control means 25 provides an ON signal to the preparing means 23 and the controllable clock feed 24 provides a signal indicating that operation including a pre-charge/pre-discharge clock is to take place. In the unprotected operating mode, the control means 25 provides an OUT signal to the preparing means and signalizes the controllable clock feed 24 to operate without the pre-charge clock.

In a preferred embodiment of the present invention, the calculating unit 20 is formed as a full-custom dual-rail pre-charge DES core, wherein the DES core also includes the preparing means 23 for pre-charge/pre-discharge. The control means 25 in this preferred embodiment of the present invention is formed as a finite state machine (FSM) which in the rounds 3 to 14 illustrated in FIG. 3a does not only generate the corresponding control signals for controlling the data path and the control part of the DES core but also provides additional signals for switching off the pre-charge process, which are used in the clock distribution tree for suppressing the pre-charge process.

In the preferred embodiment where the logic circuit is implemented as hardware as a finite state machine, it is preferred due to the Feistel structure of the DES algorithm to not only execute the first round (initial stage 1) in the protected mode, but also execute the second round (initial stage 2) in the protected mode, since in the first stage really only half of the input data is encrypted, whereas in the second stage the other half of the input data is encrypted using a cryptographic key K₂. The same applies to the last round (final stage 2) and the one but last round (final stage 1) which in the preferred embodiment of the present invention are also executed in a safe mode to be able to ward off a cryptographic reverse attack.

Depending on the actual circumstances, the inventive concept for calculating encrypted data from plaintext data or for calculating plaintext data from encrypted data may be implemented in either hardware or software. The implementation may be on a digital storage medium, in particular on a disc or CD having control signals which may be read out electronically, which may cooperate with a programmable computer system such that the method for calculating the corresponding data will be executed. In general, the invention also includes a computer program product having a program code stored on a machine-readable carrier for performing the inventive method when the computer program product runs on a computer. Put differently, the invention also includes a computer program having a program code for performing the method when the computer program runs on a computer.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. A device for calculating encrypted data from plaintext data or for calculating plaintext data from encrypted data using a cryptographic algorithm comprising an initial stage, at least one downstream intermediate stage or a final stage and at least one upstream intermediate stage, wherein the plaintext data or the encrypted data or input data derived from the plaintext data or the encrypted data may be fed to the initial stage, wherein final output data from which the encrypted output data or the plaintext output data may be derived or the encrypted data or decrypted data may be output from the final stage, wherein output data of the initial stage may be fed to the at least one intermediate stage, and wherein output data of the intermediate stage upstream of the final stage may be fed to the final stage, comprising:
a processor for performing the initial stage, the at least one intermediate stage and/or the final stage of the cryptographic algorithm,
wherein the processor is formed to perform the initial stage and/or the final stage in a manner protected against a cryptographic attack and to perform the at least one intermediate stage in a manner unprotected against a cryptographic attack.

2. The device according to claim 1, wherein the processor is formed to comprise, when performing the initial stage and/or the final stage in a protected way, a current, power and/or time profile which, regarding the data to be processed, is less expressive than a current, power and/or time profile resulting when performing the at least one intermediate stage in an unprotected manner.

3. The device according to claim 1, wherein the cryptographic attack is selected from the group consisting of simple power analysis, simple current analysis, simple time analysis, differential power analysis, differential current analysis and differential time analysis.

4. The device according to claim 1, wherein the processor is formed to comprise, when performing a calculation in the protected way, a higher energy consumption, a higher chip area consumption and/or a higher time consumption compared to performing a calculation in the unprotected manner.

5. The device according to claim 1, wherein the processor is formed in dual-rail technology for performing the initial stage and/or the final stage and is formed in single rail technology for performing the at least one intermediate stage.

6. The device according to claim 1,
wherein the processor for performing the initial stage and/or the final stage is formed using a preparing clock between two data clocks, wherein a pre-charge or a pre-discharge operation may be executed in the preparing clock, and
wherein the processor for performing the at least one intermediate stage is formed not to use a preparing clock between two data clocks.

7. The device according to claim 1,
wherein the initial stage, the final stage and the at least one intermediate stage have identical round functions.

8. The device according to claim 7, wherein a secret round key is provided for each round according to the cryptographic algorithm.

9. The device according to claim 7,
wherein the processor comprises a calculating unit for performing the round function, a controllable clock feed for providing a clock for the calculating unit, a preparer and a controller for controlling the preparer and the controllable clock feed,
wherein the calculating unit is formed in dual-rail technology, and
wherein the controller is formed
to operate, when the calculating unit executes the initial stage and/or the final stage of the cryptographic algorithm, the calculating unit in the protected manner, wherein the clock feed is controlled such that it provides a preparing clock before a useful clock and such that the preparer causes a pre-charge state or a pre-charge state of the calculating unit in the preparing clock, and
to operate, when the calculating unit executes the at least one intermediate stage, the calculating unit in the unprotected manner, wherein the clock feed is controlled such that it does not provide a preparing clock so that a pre-charge state or pre-discharge state of the calculating unit is not caused.

10. The device according to claim 9, wherein the controllable clock feed comprises a clock generator and at least one clock amplifier, wherein the controller is, when the operating unit performs the at least one intermediate stage, operative to deactivate the at least one clock amplifier.

11. The device according to claim 9, wherein the cryptographic algorithm is formed to feed input data of the round function not processed by the round function in a first round and to feed further input data of the round function not processed by the round function in a second round, and
wherein the controller is formed to operate the calculating unit for the first round and the second round in the protected manner.

12. The device according to claim 9, wherein the cryptographic algorithm is formed to generate, from a one but last round, output data not subjected to another round function and to generate, from a last round, further output data not subjected to another round function, and
wherein the controller is formed to operate the calculating unit for the one but last and the last round in the protected manner.

13. The device according to claim 1,
wherein the cryptographic algorithm comprises an initializing stage before the initial stage to generate the initial input data from the plaintext data, and wherein the processor is formed to perform the initializing stage in the unprotected manner.

14. The device according to claim 1,
wherein the cryptographic algorithm comprises a terminal stage after the final stage, and the processor is formed to perform the terminal stage where no cryptographic key is used in an unprotected manner.

15. The device according to claim 1,
wherein the cryptographic algorithm is the DES algorithm having 16 rounds, and
wherein the processor is formed to execute the first and the second round and/or the 15^{th} and the 16^{th} round in the protected manner, wherein at least one of rounds 3 to 14 may be executed in the unprotected manner.

16. The device according to claim 1, wherein the processor is formed to use a higher clock rate when performing the intermediate stage in the unprotected manner than when calculating in the protected manner.

17. A method for calculating encrypted data from plaintext data or for calculating plaintext data from encrypted data using a cryptographic algorithm comprising an initial stage, at least one downstream intermediate stage or a final stage and at least one upstream intermediate stage, wherein the plaintext data or encrypted data or input data derived from the plaintext data or the encrypted data may be fed to the initial stage, wherein final output data from which the encrypted output data or the plaintext output data may be derived or the encrypted data or decrypted data may be output from the final stage, wherein output data of the initial stage may be fed to the at least one intermediate stage, or wherein output data of the intermediate stage upstream of the final stage may be fed to the final stage, comprising the steps of:
performing the initial stage and/or the final stage in a manner protected against a cryptographic attack; and
performing the at least one intermediate stage in a manner unprotected against a cryptographic attack.

18. A computer program having a program code for performing a method for calculating encrypted data from plaintext data or plaintext data from encrypted data using a cryptographic algorithm comprising an initial stage, at least one downstream intermediate stage or a final stage and at least one upstream intermediate stage, wherein the plaintext data or encrypted data or input data derived from the plaintext data or the encrypted data may be fed to the initial stage, wherein final output data from which the encrypted output data or the plaintext output data may be derived or the encrypted data or decrypted data may be output from the final stage, wherein output data of the initial stage may be fed to the at least one intermediate stage, or wherein output data of the intermediate stage upstream of the final stage may be fed to the final stage, comprising the steps of performing the initial stage and/or the final stage in a manner protected against a cryptographic attack, and performing the at least one intermediate stage in a manner unprotected against a cryptographic attack, when the computer program runs on a computer.

19. The device according to claim 7,
wherein the processor comprises a calculating means for performing the round function, a controllable clock feeding means for providing a clock for the calculating means, a preparing means and a control means for controlling the preparing means and the controllable clock feeding means,
wherein the calculating means is formed in dual-rail technology, and
wherein the control means is formed
to operate, when the calculating means executes the initial stage and/or the final stage of the cryptographic algorithm, the calculating means in the protected manner, wherein the clock feeding means is controlled such that it provides a preparing clock before a useful clock and such that the preparing means causes a pre-charge state or a pre-charge state of the calculating means in the preparing clock, and
to operate, when the calculating means executes the at least one intermediate stage, the calculating means in the unprotected manner, wherein the clock feeding means is controlled such that it does not provide a preparing clock so that a pre-charge state or pre-discharge state of the calculating means is not caused.

20. The device according to claim 19, wherein the controllable clock feeding means comprises a clock generating means and at least one clock amplifying means, wherein the control means is, when the operating unit performs the at least one intermediate stage, operative to deactivate the at least one clock amplifier.
